(19) United States
(12) Patent Application Publication
(10) Pub. No.: US 2012/0024386 A1
(43) Pub. Date: Feb. 2, 2012

(54) SYSTEM AND METHOD FOR PRESSURE FLUSHING AND CLEANING WATER TANKS

(76) Inventor: David O'LEARY, Goodwood (CA)

(21) Appl. No.: 12/846,133

(22) Filed: Jul. 29, 2010

(51) Int. Cl. F17D 3/00

(52) U.S. Cl. 137/1; 137/561 R

(57) ABSTRACT

An apparatus is provided for draining and cleaning a tank under pressure. The apparatus comprises a conduit and a supply pipe. The conduit has a first end and a second end, the first end of the conduit for connecting to a drain port of the tank. The conduit drains water from the tank. The supply pipe resides within the conduit for delivering a pressurized fluid to the tank. The supply pipe has a first end and a second end. The first end of the supply pipe corresponds with the first end of the conduit. The pressurized fluid is introduced into the tank through the supply pipe to pressurize the tank for rapidly draining the water from the tank through the conduit.

### TECHNICAL FIELD

The present disclosure relates generally to cleaning of water tanks, and more particularly to a system and method for pressure flushing and cleaning water tanks.

### BACKGROUND

In typical hot water tanks, due to the pressure and high temperature of the water, sediment readily precipitates out of the water and settles, mostly on the bottom of the tank. The content of the sediment and how quickly the sediment accumulates varies according to water supply to the tank. Hard water supplies with high mineral content are of particular concern. High levels of iron, for example, can lead to visible staining of attached plumbing fixtures, laundry machines or laundry, or foul smelling water. The gradual accumulation of sediment reduces the heating efficiency of the tank, as the sediment functions as an insulating blanket over the electric heating elements or over the boiler surface at the bottom of oil or gas fired tanks. Loud cracks and popping sounds are good indicators of tanks with large deposits of sediment, as trapped water boils under the sediment. This boiling stress can shorten the life of the hot water tank and/or lead to failure as tiny cracks develop and propagate in the protective glass lining of the tank. In hot water tanks sediment build up, left unchecked, reduces the capacity of the tank over time to deliver its rated capacity of hot water as the water capacity is continually displaced with sediment. In worst-case scenarios, the sediment may build up high enough to cover the tank's temperature and safety probes and can result in unsafe operating pressures and temperatures as the heating controls of the tank will call for heat longer than needed.

Many hot water tank manufacturer's maintenance procedures recommend a periodic (e.g., twice per year) draining of several gallons of water from hot water tanks using an attached garden hose leading to a nearby drain. In gas and oil fired tanks this draining procedure is quite ineffective, as typically only a small fraction of sediment is drained. This is due to the steep, concave shape of the bottom of the tank that is designed as such to maximize the heat transfer area from the boiler and to help maintain the integrity of the pressure vessel. With the tank under typical domestic or commercial water pressure, opening the drain valve creates an area of immediate low hydraulic pressure only near the drain valve. Usually, only the sediment immediately near the drain valve is removed as evacuated water is quickly replaced by the nearby cold water inlet tube.

A more effective and recognized method for flushing the sediment is to fully drain the tank. This is accomplished by shutting off the heating energy source to the tank to avoid damage to the tank heating and safety controls and turning off the cold water supply to the tank. In conventional approaches, the drain valve is opened and tank drains based on the force of gravity, usually with a higher-elevation faucet in the home opened to replace the draining water with air. Most typical modern hot water tanks have child-resistant, anti-scald, low-flow drain valves, which requires up to 90 minutes to drain a standard 60 gallon tank and all of the connected, higher-elevation hot water plumbing lines. When the last few gallons of water drain out from the tank, additional sediment can be removed, as the moving water drains from all sides of the concave bottom. To remove additional quantities of sediment the bottom of the tank can be partially refilled by turning on the cold water supply and then draining additional quantities of water again along with the sediment the water carries. This is an iterative process and may take many hours for a tank with heavy sediment build-up before the drain water runs clear of sediment.

Further, with the conventional approach, the drained water either spills onto the floor surrounding the tank or drains through a hose connected to the tank. However, since water tanks are usually installed in the basement, this creates additional problems if the user wishes to drain the tank to a sink or drain that lies above the tank, or if the user wishes to drain the water to the exterior of the home.

It would be desirable to have a system and method for flushing and cleaning water tanks that addresses at least some of the shortcomings of the conventional systems.

### SUMMARY

One aspect of the present disclosure provides an apparatus for draining a tank comprising a conduit and a supply pipe. The conduit has a first end and a second end, the first end of the conduit for connecting to a drain port of the tank and the conduit for draining water from the tank. In one example, the supply pipe may reside within the conduit for delivering a pressurized fluid to the tank. The supply pipe has a first end and a second end, the first end of the supply pipe corresponding with the first end of the conduit. The pressurized fluid may be introduced into the tank through the supply pipe to pressurize the tank for rapidly draining the tank through the conduit.

Another aspect of the present disclosure provides an apparatus for draining a tank comprising an adaptor and a pressure conduit. The adaptor may be configured to couple a drain conduit to a drain port of the tank, the adaptor comprising an orifice permitting fluid communication between the drain conduit and contents of the tank. The pressure conduit may extend through the orifice of the adaptor delivering pressurized fluid into the tank while allowing contents of the tank to exit the tank through the drain conduit.

Another aspect of the present disclosure provides a method for draining a tank comprising: providing through an orifice a path for draining water from the tank; and pressurizing the tank by introducing pressurized fluid into the tank through the same orifice, thereby draining the water in the tank under pressure.

### BRIEF DESCRIPTION OF THE DRAWINGS

Reference will now be made to the drawings, which show by way of example, embodiments of the present disclosure, and in which:

FIG. 1 shows a side sectional view of a typical basement installed hot water heater that is suitable for use with a method and apparatus according to one aspect of the present description;

FIG. 2 shows in schematic form an apparatus for pressurizing and draining tanks according to one aspect of the present description; and

FIG. 3 shows in flow chart form a method of pressurizing and draining tanks according to one aspect of the present description.

### DETAILED DESCRIPTION

The present description relates to a safer and faster method and apparatus for removing sediment build up present in typical water tanks. The apparatus may be scaled up or down and adapted to hot water tanks, boilers, well water pressure tanks, or pressure vessels of any type or size. However, in one example, the apparatus is primarily designed for use for residential, marine and/or commercial hot water tanks, for example in the 20-150 gallon range. Suitable hot water tanks for use with the present apparatus and method may be electric, heat-exchanger, oil and/or gas fired, although any hot water tank may be used with the present apparatus and method with suitable modifications according to the design criteria of a particular application. A universal feature of typical hot water tanks is the placement of a threaded drain port and valve at the bottom of the tank. The present method may replace the valve in the threaded port, either temporarily or permanently, for access to the inside of the tank in order to flush and clean the tank under an applied pressure.

The method and apparatus may safely and quickly drain a standard 60 gallon hot water tank, for example in less than 6-10 minutes, thereby saving substantial time over the conventional approach of allowing the water to drain out of the tank through the manufacturer provided valve under the force of gravity. The conventional iterative process of having to partially refill and re-drain the tank is improved by a more effective, higher velocity, vortex action created by pressurized air forcing water out of the bottom of the tank continually to more completely flush and clean the sediment build-up from the bottom of the tank. The improved efficiency and effectiveness of the described method and apparatus aims to shorten tank cleaning time and reduce the disruption of the hot water supply to the homeowner, boat owner or business for cleaning of the tank, therefore making it more tolerable for tank owners to accommodate a regular schedule for hot water tank cleaning in order to prolong the tank lifespan and improve the tank operating efficiency.

The present description provides a method and apparatus for safely pressure flushing and cleaning a hot water tank, or other pressure vessel, of sediment. In one embodiment, little or no modification to the hot water tank is needed. Using the existing drain valve port at the bottom of a typical hot water tank, the method and apparatus aims to safely inject pressurized air into the tank to facilitate pressurized cleaning. The apparatus may replace the manufacturer provided drain valve of the hot water tank with an exterior integrated four valve system attached to the drain valve port, allowing for the safe introduction of pressurized air into the tank. At the same time, a separate, high volume pathway may be provided to evacuate the water and sediment from the tank under pressure. Depending on the orientation of the apparatus, the injected air under pressure may be used to drain or rinse the tank of water, or the apparatus may be used to direct a stream of air towards the bottom of the tank to create a high-velocity, vortex action to clean and remove sediment.

Additionally, as the hot water tank or pressure vessel is cleaned under applied pressure, exit waste water forced out of the tank by the applied pressure may be directed to higher elevations (e.g., up to 175 feet higher than the tank, or even higher). This is advantageous when waste water discharge options below the elevation of the tank are not fast flowing or available, and moreover, in marine applications where hot water tanks or potable water supply pressure vessels are typically installed as low as possible, usually well below the boat's water line to help maintain a low centre of gravity for the boat.

One objective of the method and apparatus may be to drain, flush and/or clean a hot water tank of sediment in a safer, faster, and/or more effective way with less spillage and/or overflow as compared to the conventional approaches. Another objective may be to provide an apparatus that is field installable with little or no modification needed to the hot water tank to be cleaned other than removing the existing drain valve and attaching the apparatus. The apparatus may be configured for permanent installation, manufactured into the design of the tank, or temporarily installed to accommodate periodic tank cleaning.

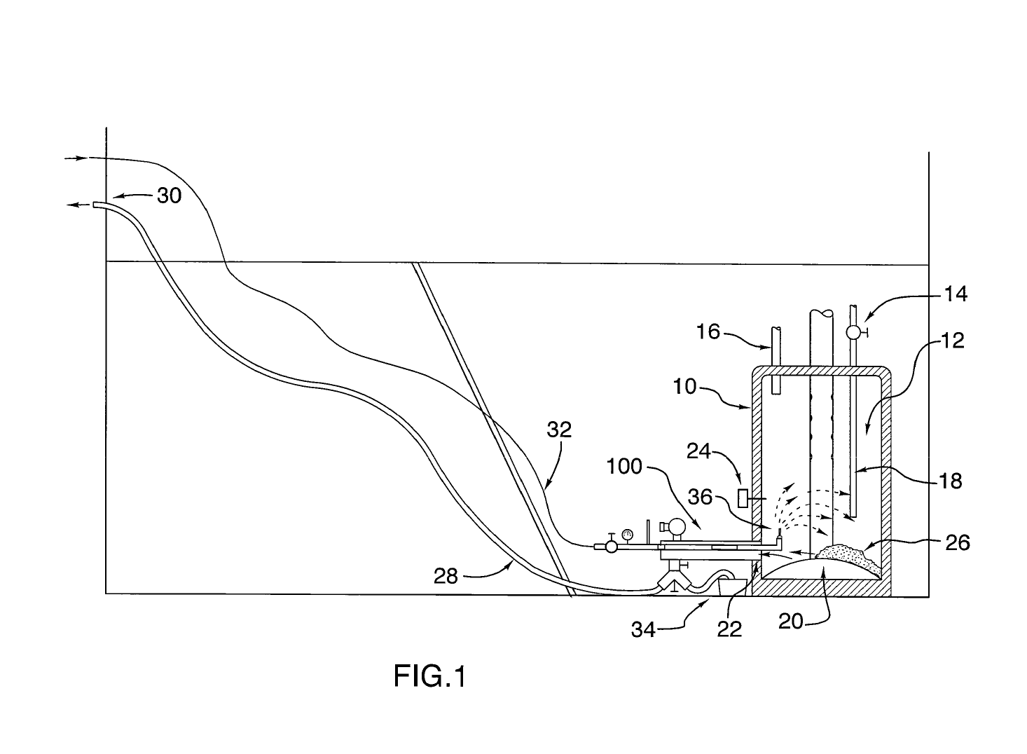

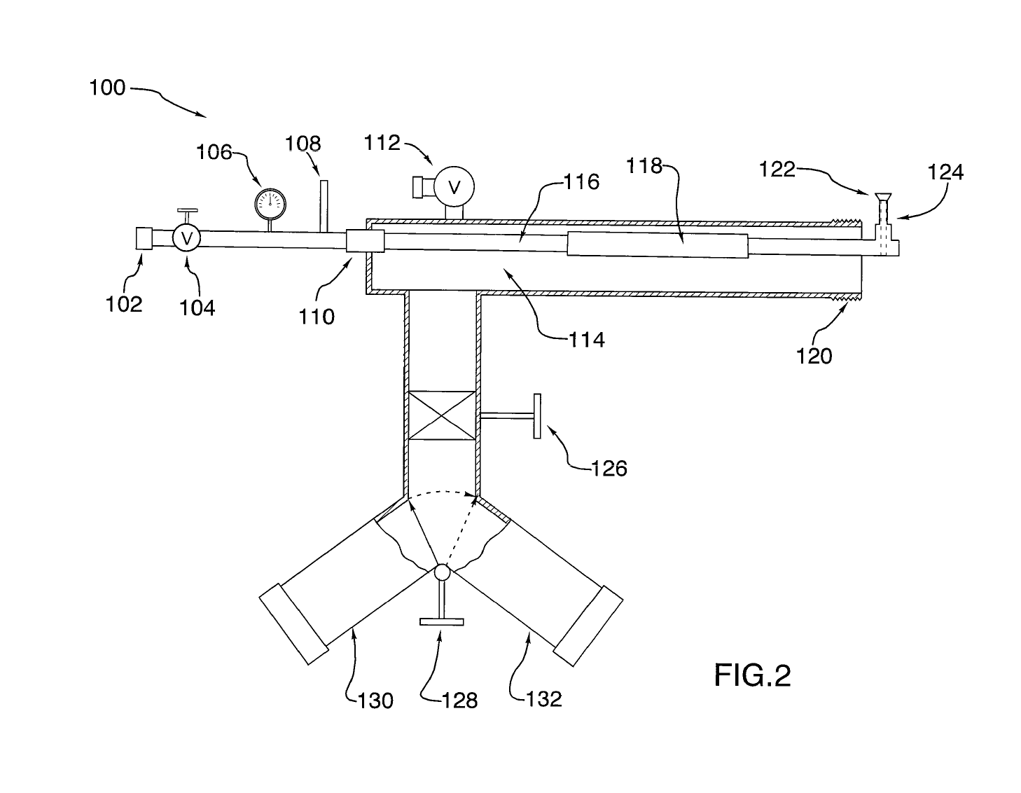

Reference is now made to both FIGS. 1 and 2. FIG. 1 shows a side sectional view of a typical basement installed water tank 10 that is suitable for use with a method and apparatus according to one aspect of the present description. In one example, the water tank 10 may be a hot water heater tank. FIG. 1 also shows the apparatus 100 attached to the water tank 10. FIG. 2 shows in schematic form the apparatus 100 for pressure flushing and cleaning water tanks according to one aspect of the present description.

Referring to FIG. 1, tank 10 generally comprises an interior cavity 12, a cold water inlet valve 14, a hot water exit pipe 16, a cold water inlet dip tube 18, a concave boiler surface 20, a tank drain exit port 22, and tank heating controls 24. Sediment build-up in the water tank 10 is indicated by reference 26. The apparatus 100 is shown connected to a drain hose 28 leading to a higher elevation drain 30. The apparatus 100 is also shown connected to an air supply hose 32. The apparatus 100 is further shown working in conjunction with a specimen collector 34. The apparatus is shown as generally having a nozzle 36. Apparatus 100 is described is greater detail in connection with FIG. 2, below. Water tank 10 is shown to illustrate an example of a water tank that is suitable for use with a method and apparatus according to one aspect of the present description, however FIG. 1 is not intended to be limiting in this respect and the apparatus 100 may be used in conjunction with any suitable water tank.

Referring to FIG. 2, the apparatus 100 generally comprises an air supply fitting 102, an air supply valve 104, an air pressure gauge 106, a handle and/or orientation indicator 108, a fitting 110 that may provide for rotation of an air supply pipe 116 within a conduit 114, a pressure relief valve 112 with optional fitting for a hose, the air supply pipe 116, a fitting 118 to enable length adjustment of the air supply pipe 116, a threaded fitting 120 on the conduit 114 for attachment to tank drain port 22, a threaded nozzle 122, a nozzle pipe 124, a water exit valve 126, a water diversion valve 128, a waste water exit fitting 130, and a specimen collection fitting 132. In one example, the waste water exit fitting 130 and the specimen collection fitting 132 may be translucent. In one example, the nozzle pipe 124 may be spring loaded and auto-retracting. In one example, the conduit 114 may also be referred to as a drain pipe or water exit pipe 114.

Many of the elements of the apparatus 100 may be optional, such as the air pressure gauge 106, the handle and/or orientation indicator 108, the fitting 110, and the fitting 118. The water diversion valve 128 may also be optional, with only one of the waste water exit fitting 130 the specimen collection fitting 132 being needed for the apparatus 100 to function. Further variations of the apparatus 100 may be apparent to those skilled in the relevant arts according to the design criteria of a particular application.

The apparatus 100 generally comprises four integrated valves, the air supply valve 104, the water exit valve 126, the waste water diverting valve 128, and the pressure relief valve 112. The valves 104, 112, 126, and 128 may manage the safe flow of air into the tank 10, and water and/or air exiting the tank 10. The apparatus 100 may attach to the hot water tank 10 with a threaded connection between the tank drain port 22 and the threaded fitting 120 found at a first end of the apparatus 100. While an exemplary thread connection is mentioned, any suitable type of connection may be used to meet the design criteria of a particular application. In operation, the valves 104, 112, 126, and 128 work together to maintain a safe, sealed pressure environment in the water tank 10, enabling the water tank 10 to be drained and cleaned at pressures higher than atmosphere (e.g., 1 bar). In one example, hyperbaric pressures may be used up to several times atmosphere, for example up to 75 PSI for typical residential plumbing systems.

The air supply valve 104 may be used to allow for the introduction of pressurized air into the water tank 10 via the air supply pipe 116 when the air supply valve 104 is placed in the open position. The air supply pipe 116 may be attached through fitting 102 found at a second end of the apparatus 100 to a compressed air source (e.g., an air compressor and supply hose) powerful enough to continuously deliver the needed pressure and velocity of air for the size of water tank 10 being cleaned. This stream of air, which travels through the air supply pipe 116 and exits the nozzle 122, is orientated upwards by the nozzle 122 during the draining or rinsing of the tank 10, optionally with the guidance of a marked indicator on the apparatus 100 which indicates orientation, for example handle and/or orientation indicator 108. The handle and/or orientation indicator 108 may also serve as a handle to enable the user of the apparatus 10C to rotate the apparatus 100 during fitting to the tank 10.

During the tank draining and rinsing procedure, the stream of air may be orientated to be perpendicular to the bottom of the tank 10 (e.g., flowing upwards relative to the tank 10). During the sediment cleaning and sediment removal procedure, the stream of air may be oriented to parallel to the bottom of the tank 10 (e.g., flowing across the bottom of the tank 10). To accommodate hot water tanks of different types and construction, the air supply pipe 116 may be adjustable via fitting 118 to enable the depth of the nozzle inside the tank to be adjusted. Nozzle pipe 124 may be attached to the end of the air supply pipe 116 where the air stream exits. In one example, nozzle pipe 124 may be of lesser diameter than air supply pipe 116 and may be internally spring-loaded and/or auto-retracting and may have nozzle 122 is attached thereto. The spring may ensure that nozzle pipe 124 is collapsible to facilitate attachment and removal of the apparatus 100 to the hot water tank 10 through the tank drain port 22, without interference of the nozzle pipe 124.

When air is introduced into the tank 10, the pressure of the air overcomes the force of the spring of the nozzle pipe 124 and extends the nozzle 122 slightly outward. For example, at approximately 90 degrees to the air supply pipe 116 as shown in FIG. 2, greater separation is provided between the incoming air stream and water exiting through the water exit pipe 114. The end of the nozzle pipe 124 may be threaded to accommodate attachment of nozzles 122 of varying shapes and diameters to further adjust the velocity and direction of air flow as desired. In one example, the air supply valve 104 may be regulated with a fully adjustable ball valve and pressure in the hot water tank 10 may be monitored via the optional pressure gauge 106 which is attached to the air supply pipe 116.

In one embodiment, pressurized water may be used in place of air, with a water supply attached to the air supply valve 104 to assist in the removal of heavy sediment once the tank is drained.

The water exit valve 126 may be of a larger diameter relative to the air supply valve 104 and air supply pipe 116. In one example, the water exit valve 126 may be an adjustable ball valve that allows for regulating the flow of water exiting the tank 10 under pressure through the water exit pipe 114. The water exit pipe 114 may fully encase and/or enclose the smaller air supply pipe 116 to maintain the pressure of the system. In other words, the air supply pipe 116 may reside within the water exit pipe 114. Further, in one example, an axis of the air supply pipe 116 may be substantially parallel to an axis of the water exit pipe 114. As such, the water exit pipe 114 and the air supply pipe 116 may be arranged in a coaxial or nearly coaxial manner with the air supply pipe 116 residing inside the water exit pipe 114 such that the user of the apparatus only has to grasp the exterior of the water exit pipe 114 to hold and manage the apparatus 100.

The waste water diverting valve 128 may be connected downstream from water exit valve 126. The waste water diverting valve 128 may direct the flow of water exiting the tank 10 to a nearby container for specimen collection, for example through collection fitting 132 and any coupled hose or pipe, or to a hose or pipe coupled to the waste water exit fitting 130 to drain the flowing water to the outside or to a large capacity drain, at any suitable elevation (e.g., either below or above the water tank 10). In one example, the exit fittings 130, 132 coupled to the waste water diverting valve 128 may be translucent to enable for easy visual inspection of the level of sediment carried by the water, in order to determine when the tank is clean. The waste water diverting valve 128 is optional. The apparatus 100 may also be constructed with a single exit fitting (e.g., only one of the fittings 130, 132 and no diverting valve 128).

In one example, the pressure relief valve 112 may be an automatic, high flow pressure relief valve designed to automatically open if the maximum recommended domestic or commercial water supply pressure (e.g., typically 75 PSI) is exceeded as a result of the introduction of pressurized air through the air supply valve 104 and into the water tank 10. Typical plumbing codes only require one shut-off valve (e.g., valve 14) to the water tank 10 on the cold water supply side. During use of the apparatus 100, hot water plumbing pipes and fixtures connected to the water tank 10 form part of the same closed system and are subject to substantially the same pressures used to drain and clean the tank 10. The pressure relief valve 112 aims to ensure that the connected hot water plumbing lines and fixtures are not stressed beyond intended operating design pressures. Optionally, the pressure relief valve 112 may also be connected to a drain hose for safely draining water to a drain or container, in the event that the pressure relief valve 112 is activated by the excessive introduction of pressurized air.

Typical modern hot water tanks are equipped with temperature and pressure relief (TPR) valves and are designed to open to prevent tank explosion or rupture in the most serious of tank heating control failures (e.g., typically above 150 PSI/200° F. in a residential setting). The plastic solenoid hot water valves common in modern residential dish washers and clothes washers typically fail before this emergency tank pressure level is reached. Therefore, pressure relief valve 112 in the apparatus 100, while optional, is advisable to protect the connected hot water pipes and fixtures. The pressure relief valve 112 may be field installable and/or replaceable to accommodate different water supply pressure tolerances.

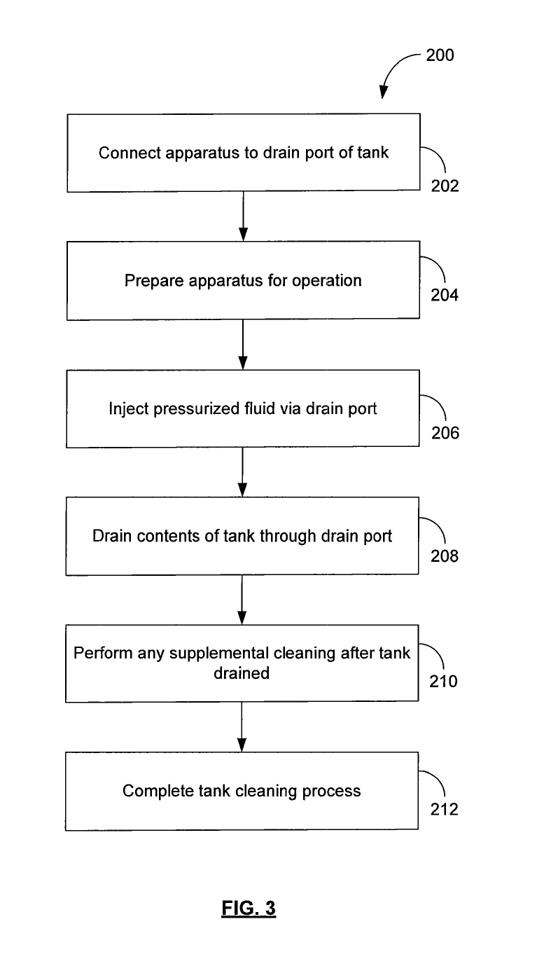

Referring now to FIG. 3, a flow chart is shown illustrating a method 200 of pressurizing and draining a tank in accordance with one aspect of the present description. In one example, the tank may be a water tank such as a hot water heater. The method 200 is described with reference to the exemplary application of a hot water tank, however the method 200 may be used with any suitable tank. To use the apparatus 100, some preparation of the tank 10 is advisable. The cold water inlet valve 14 on the hot water tank 10 should be turned off to prevent potential back pressure being introduced into a municipal supplied water supply system. Additionally, the tank 10 heating controls 24 should also be turned off to avoid temperature and/or pressure damage to the heating controls by attempting to heat an empty or partially empty tank while the tank 10 is being cleaned. Standing pressure in the tank 10 and attached plumbing system should be released first before removing the existing drain valve from the tank exit port 22 by opening the existing drain valve. Once excess pressure is relieved inside the tank 10 (e.g., above ambient air pressure) and once the water in the tank 10 has cooled enough to avoid scalds or burns to the operator, the existing drain valve may be removed from tank exit port 22.

With no other hot water plumbing fixtures open in the plumbing attached to the tank 10, the water in the tank 10 will not freely drain, accommodating easy replacement of the removed drain valve with the apparatus 100 while the tank 10 is full of water. During installation of the apparatus 100 to the tank exit port 22, the threaded nozzle 122 and nozzle pipe 124 may be oriented downwards relative to the water exit pipe 114 by rotating the air supply pipe 116 relative to the water exit pipe 114 to facilitate entry into the threaded tank exit port 22. The axis of the air supply pipe 116 located inside the water exit pipe 114 may be offset from centre (e.g., the axis of the water exit pipe 114), as illustrated in FIG. 2, providing space for the nozzle 122 and nozzle pipe 124 to fit inside the tank's exit port 22 during installation.

As shown at a block 202, the apparatus 100 is connected to the tank 10, for example the threaded fitting of the apparatus 100 may be threaded into the threaded tank exit port or drain port 22 of the hot water tank 10. Sealing Teflon tape may be used on the threaded fitting 120, with all four valves of the apparatus 100 in the closed position during installation at block 202.

In one alternative example, the water exit pipe 114 and the air supply pipe 116 may be separate pipes. For example, the water exit pipe 114 may be connected to the tank exit port 112 and the air supply pipe 116 may be connected to another entry point, such as a valve located at the tank heating controls 24 or a temperature relief valve on the tank 10. As an example only, the method 200 is described in connection with the exemplary apparatus 100 shown in FIG. 2.

Next, at an optional block 204, the apparatus 100 may be prepared for operation. Preparation for operation may include attaching a pressurized air supply hose to the air supply fitting 102 and/or attaching drain hoses to the water diversion valve 128, via the waste water exit fitting 130 and/or the specimen collection fitting 132. A separate drain hose may further be connected to the pressure relief valve 112 to safely direct the water to a drain or container in the case of activation of the pressure relief valve 112.

Next, at a block 206, pressurized fluid is injected into the tank 10 through drain port 22. In one example, the pressurized fluid may be compressed air. However, any suitable pressurized fluid, such as water or any other gas (e.g., argon, helium, nitrogen, oxygen, etc.), may be used to meet the design criteria of a particular application. Subsequently and often simultaneously, at a block 208, the contents of the tank are allowed to drain through the drain port and into the drain conduit (e.g., the water pipe 114). In the present example, water is drained from the tank 10 by providing a path for draining water from the water tank 10 thereby draining the water in the water tank 10 under pressure. Blocks 206 and 208 may be facilitated through the same orifice (e.g., the drain port 22). The water exit valve 126 may be opened (e.g., at the block 208) and the air supply valve 104 may be opened (e.g., at the block 206) to introduce pressurized air into the tank 10 therefore pressurizing the tank 10 for rapid draining by forcing the water in the tank 10 out through the exit water pipe 114. To drain the tank 10, the air supply pipe 116 may be oriented within the exit water pipe 114 using the handle 108 so that the air nozzle 122 and nozzle pipe 124 direct incoming pressurized air upwards towards the top of the tank 10. The operator may regulate an air supply valve and monitor the pressure gauge 106 accordingly to ensure air pressure is kept below the safety pressure relief valve 112 setting.

Next, at an optional block 210, supplemental cleaning of the tank 10 may occur, as needed. Once all or nearly all of the water has been evacuated from the tank 10, the air supply pipe 116 may then by oriented using the handle 108 so that the nozzle 122 is placed approximately parallel to the bottom of the tank 10. Depending on the construction and design of the tank 10, nozzles of different shapes and diameters are available and maybe threaded, beforehand, into the nozzle pipe 124 for the most effective air flow for cleaning according to the particular type of tank 10 being cleaned. The water exit valve 126 may be closed and the tank 10 may be allowed to re-fill with an appropriate amount of water (e.g., several gallons) by reopening the tank cold supply valve 14. Once a sufficient amount of water has been placed in the tank 10, the valve 14 may be closed and the air supply valve 104 and the water exit valve 126 may again be opened. Optionally, the tank cold water supply may be left on or partially on while the tanked is cleaned under pressure. The high velocity, high pressure air may create a clock-wise (or counter clock-wise, depending on the orientation of air supply pipe 116 and nozzle 122) vortex action on the bottom of the tank 10, and may create a low hydraulic pressure exit point at the tank drain port 22 for the water and suspended sediment to exit through the exit water pipe 114. With the water tank 10 cold water supply still open, the operator may continue the cleaning procedure of independently opening and closing the air supply valve 104 and exit water valve 126 as desired until the draining water is clear of sediment, for example as observed in the waste water diversion fittings 130, 132, which may be translucent. The operator may choose to momentarily use the waste water diversion valve 128 for specimen collection in a container for future analysis of the sediment.

Next at a block 212, the tank cleaning process is complete. When the cleaning cycle is completed, the water exit valve 126 and the air supply valve 104 may be turned off. It may be desirable to completely refill the tank 10 with cold water and complete one more pressurized drain cycle to rinse the tank 10 of any sediment that may have splashed onto the walls of the tank 10 or the internal heating elements and/or controls during the tank cleaning process.

Once the tank 10 has been rinsed and drained, the air supply valve 104 may be closed and the compressed air supply disconnected from the air supply fitting 102. To relieve any residual air pressure in the tank 10, the exit water valve 126 may be opened momentarily. With the tank 10 empty of water and any pressurized air, the apparatus 100 may be removed and the original drain valve reinstalled in the tank drain port 22 and tank 10 refilled and returned to normal operation.

The embodiments of the present disclosure described above are intended to be examples only. Those of skill in the art may effect alterations, modifications and variations to the particular embodiments without departing from the intended scope of the present disclosure. In particular, selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

1. An apparatus for draining a tank, comprising:
a conduit having a first end and a second end, the first end of the conduit for connecting to a drain port of the tank, the conduit for draining water from the tank; and
a supply pipe residing within the conduit for delivering a pressurized fluid to the tank, the supply pipe having a first end and a second end, the first end of the supply pipe corresponding with the first end of the conduit,
wherein the pressurized fluid is introduced into the tank through the supply pipe to pressurize the tank for rapidly draining the tank through the conduit.

2. The apparatus according to claim 1, wherein the conduit includes a drain pipe, the pressurized fluid includes compressed air, and the tank includes a water tank.

3. The apparatus according to claim 1, further comprising:
a nozzle pipe coupled the first end of the supply pipe; and
a nozzle coupled to the nozzle pipe,
wherein the nozzle directs the flow of pressurized fluid into the tank.

4. The apparatus according to claim 1, wherein an axis of the conduit is substantially parallel to an axis of the supply pipe, the conduit further having a threaded first end for attachment to the drain port.

5. The apparatus according to claim 1, further comprising:
a water exit valve coupled to the conduit for controlling drainage of the water from the tank; and
a valve coupled to the second end of the supply pipe for controlling the introduction of the pressurized fluid into the supply pipe.

6. The apparatus according to claim 5, further comprising:
a pressure relief valve coupled to the conduit for opening automatically if a maximum pressure threshold is exceeded as a result of the introduction of the pressurized fluid through the supply pipe; and
a diversion valve attached adjacent the water exit valve for controlling the flow of draining water through one of two drainage paths.

7. The apparatus according to claim 1, wherein pressurization of the tank using the pressurized fluid is sufficient to drain the tank in less than ten minutes for a typical domestic water heater tank of between forty and seventy gallons.

8. The apparatus according to claim 1, wherein pressurization of the tank using the pressurized fluid is sufficient to drain the tank through a hose coupled to the conduit to an elevation higher than an elevation of the tank.

9. The apparatus according to claim 1, wherein the supply pipe extends through the second end of the conduit through a fitting that provides for rotation of the supply pipe within the conduit, the second end of the supply pipe extending beyond the second end of the conduit.

10. The apparatus according to claim 9, wherein the supply pipe has a supply valve coupled adjacent the second end of the supply pipe for controlling the introduction of the pressurized fluid into the supply pipe and a gauge coupled adjacent the second end of the supply pipe showing pressure of the pressurized fluid supplied to the supply pipe.

11. The apparatus according to claim 9, further comprising a fitting coupled to the second end of the supply pipe for attaching the supply pipe to a pressurized fluid source.

12. A method for draining a tank, comprising:
providing through an orifice a path for draining water from the tank; and
pressurizing the tank by introducing pressurized fluid into the tank through the same orifice, thereby draining the water in the tank under pressure.

13. The method for draining the tank according to claim 12, further comprising, before pressurizing the tank:
removing an existing valve from a drain port of the tank;
connecting an apparatus for pressurizing and draining the tank to the drain port of the tank; and
preparing the apparatus for operation,
wherein the orifice includes the drain port and the tank includes a hot water tank.

14. The method for draining the tank according to claim 12, further comprising:
performing supplemental cleaning of the tank after substantially all of the water is drained from the tank.

15. The method for draining the tank according to claim 12, wherein pressurization of the tank using the pressurized fluid is sufficient to drain the tank in less than ten minutes for a typical domestic water heater tank of between forty and seventy gallons.

16. The method for draining the tank according to claim 12, wherein pressurization of the tank using the pressurized fluid is sufficient to drain the tank through a hose coupled to the apparatus to an elevation higher than an elevation of the tank.

17. An apparatus for draining a tank, comprising:
an adaptor configured to couple a drain conduit to a drain port of the tank, the adaptor comprising an orifice permitting fluid communication between the drain conduit and contents of the tank; and
a pressure conduit extending through the orifice of the adaptor delivering pressurized fluid into the tank while allowing contents of the tank to exit the tank through the drain conduit.

18. The apparatus according to claim 17, wherein the pressurized fluid includes compressed air, the tank includes a water tank, an axis of the drain conduit is substantially parallel to an axis of the pressure conduit, and the drain conduit further has a threaded first end for attachment to the drain port.

19. The apparatus according to claim 17, further comprising:
a nozzle pipe coupled to a first end of the drain conduit; and
a nozzle coupled to the nozzle pipe,
wherein the nozzle directs the flow of pressurized fluid into the tank.

20. The apparatus according to claim 17, further comprising:
a valve coupled to the drain conduit for controlling drainage of the tank;
a valve coupled to the pressure conduit for controlling the introduction of the pressurized fluid into the pressure conduit;
a pressure relief valve coupled to the drain conduit for opening automatically if a maximum pressure threshold is exceeded as a result of the introduction of the pressurized fluid through the pressure conduit; and
a diversion valve attached adjacent the water valve for controlling the flow of draining fluid through one of two drainage paths.
